(19) United States
(12) Patent Application Publication
(10) Pub. No.: US 2026/0079923 A1
(43) Pub. Date: Mar. 19, 2026

(54) LARGE LANGUAGE MODEL (LLM) SELECTION AND CHAINING

(71) Applicant: Salesforce, Inc., San Francisco, CA (US)

(72) Inventors: Brady SAMMONS, Walnut Creek, CA (US); Avanthika RAMESH, San Francisco, CA (US); Karen YIN, San Jose, CA (US); Jan Adriaan KRUGER, Fuquay-Varina, NC (US)

(73) Assignee: Salesforce, Inc., San Francisco, CA (US)

(21) Appl. No.: 19/020,246

(22) Filed: Jan. 14, 2025

Related U.S. Application Data
(60) Provisional application No. 63/695,152, filed on Sep. 16, 2024.

(51) Int. Cl. G06F 16/242; G06F 16/23; G06F 40/211

(52) U.S. Cl. CPC G06F 16/243; G06F 16/2379; G06F 40/211

(57) ABSTRACT

Disclosed herein are system, method, and computer program product aspects for a selecting an LLM from among a plurality of available LLMs for processing and/or chaining multiple LLMs together. A system maintains a list of available LLMs and LLM versions. A user selects a desired LLM from among those available, and provides the system with a request to be processed. The system obtains relevant metadata associated with the selected LLM as well as stored data referenced by or necessary for processing the user request. The system then generates a prompt based on the metadata and the retrieved data consistent with the prompting guidelines of the selected LLM. The system then prompts the LLM accordingly, which generates a responsive output for responding to the user request. Both LLM selection and LLM chaining can be achieved with little or no coding required.

### CROSS-REFERENCE TO RELATED APPLICATIONS

The present application claims benefit to U.S. Provisional Patent Application No. 63/695,152, filed Sep. 16, 2024, which is hereby incorporated by reference in its entirety.

### BACKGROUND

Large Language Models (LLMs) are machine learning (ML) models that can comprehend and generate human language text and other generative outputs based on a large data training set. LLMs are starting to become integrated into a wide variety of fields, such as research, agent response, healthcare, translation, content creation, and a wide array of business applications.

In order to cause an LLM to produce responsive action, it is often necessary to write a prompt to the LLM. This prompt is essentially an instruction to the LLM. Different LLMs may use different prompts, and one prompt may not necessarily be interchangeable with another. This has given rise to new professions, such as prompt engineer, who may be a primary resource for prompting LLMs to generate desired responses. These prompt engineers often are only required to become proficient in a small number of LLMs that are used by a given company. Likewise, the complexity associated with prompting different LLMs may prevent usage of a large number or a wide variety of LLMs.

One or more aspects of the present disclosure relate to the field of machine learning (ML) models, and more specifically to a selecting a specific ML model for responding to a particular request from among several different models and/or versions, without the need for one or more prompt engineers.

### BRIEF DESCRIPTION OF THE DRAWINGS

The accompanying drawings are incorporated herein and form a part of the specification.

FIG. 1 illustrates a block diagram of an exemplary LLM selection environment, according to aspects of the present disclosure.

FIG. 2 illustrates a block diagram of an exemplary LLM selection system for use in the LLM selection environment according to aspects of the present disclosure.

FIG. 3 illustrates a flowchart diagram of an exemplary method for LLM selection according to aspects of the disclosure.

FIG. 4 illustrates a process flow diagram of an exemplary LLM selection process according to aspects of the present disclosure.

FIG. 5 illustrates a flowchart diagram of an exemplary LLM chaining method according to aspects of the present disclosure.

FIG. 6 illustrates a process flow diagram of an exemplary LLM chaining process according to aspects of the present disclosure.

FIG. 7 illustrates a user interface according to aspects of the present disclosure.

FIG. 8 illustrates a user interface according to aspects of the present disclosure.

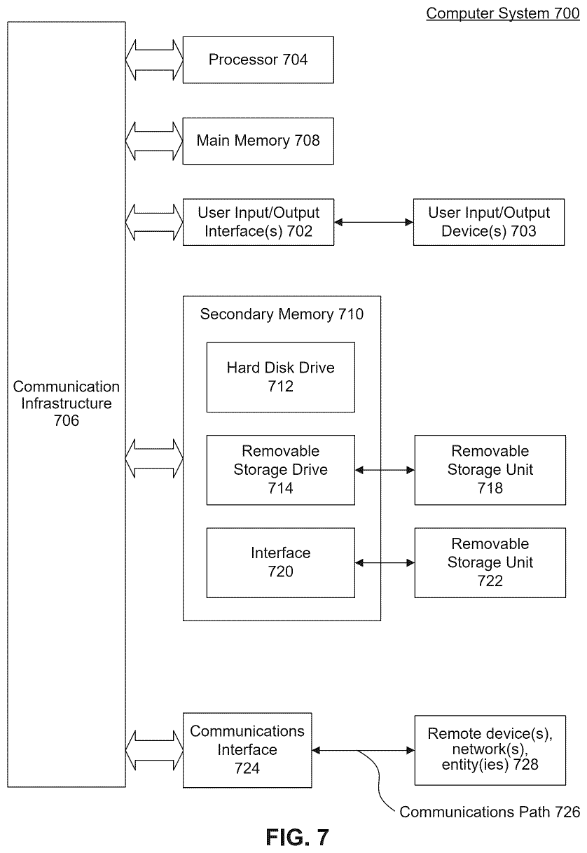

FIG. 7 illustrates a block diagram of an exemplary computer system according to aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product aspects, and/or combinations and sub-combinations thereof, for allowing a user to select a Large Language Model (LLM) from among several available LLMs or versions of an LLM.

Many different business computer environments, and in particular those that serve customer or subscriber needs, may include one or more machine learning (ML) models that can be used by customers to carry out various tasks. For example, a customer sales environment may be used by subscribers to track sales team statistics, as well as account information of their customers. Such account information may include information relating to a sales individual or sales team, including volume or dollars sold, number of accounts being handled, and customer business and contact information, and sales targets. Meanwhile, the account information may further include information relating to the different accounts, such as customer business information, primary contacts, pending accounts, account targets etc. In such an environment, machine learning models may be made available to the subscribers in order to assist them with their various business tasks. In aspects, such tasks may include a wide range of requests, from something as fundamental as making a request for information (e.g., “what is the contact information of the primary point of contact at Company A?”) to something that far more complex (e.g., “For all accounts currently assigned to Salesperson A, generate a spreadsheet showing percentages of sales to those accounts over the various products purchased by those accounts.”).

Notably, while there has been significant movement in the business industry toward the use of LLMs in their day-to-day operations, most companies are very limited in the LLMs that are available to them. Some may have licenses for only a small subset of available LLMs, while others may attempt to develop their own in-house LLMs for use by their employees. However, different LLMs have different strengths, whereas others have certain weaknesses. For example, some may be faster but less accurate, whereas others may be slower but more accurate. When a company elects to avail themselves of only one or a very small subset of LLMs, the ability to take advantage of the unique differences among different LLMs is lost. As a result, a business's specific needs may not be met. Therefore, there is a need in the industry for a way to allow businesses to select an LLM that suits their particular needs.

In aspects of the present disclosure, numerous LLMs are housed in a central database or across multiple databases or servers. In aspects, the LLM selection system provides the user with a list of the available LLMs, from which the user can choose a desired LLM for processing. Once the LLM selection is received, the system retrieves syntax and formatting rules for generating a prompt to the particular LLM. Meanwhile, the user provides the system with their “request,” which may include one or more actionable items or requests. Based on the customer's request and the retrieved syntax and formatting information (e.g., LLM metadata), the system generates a final LLM prompt, which it then provides to the selected LLM for processing. The selected LLM returns its output, which the system then processes and forwards to the customer.

In other aspects of the present disclosure, LLM selection and chaining can be carried out with little or no programming. For example, users may be capable of selecting LLMs, as well as their associated inputs and types, within a GUI or project flow. This not only greatly streamlines the process of configuring LLM usage and chaining functionality, but also allows it to be done by most business employees, without the need for LLM specialists.

In aspects, the system may be further integrated into a hosting environment, able to retrieve records or other data from the hosting environment for use in the prompt and/or able to write new data to one or more databases associated with the hosting environment based on the output of the selected LLM. In aspects, the LLMs may include multi-modal support, being capable of receiving in a prompt and/or outputting one or more images, audio, video, etc.

In order to take further advantage of the differences in LLMs, aspects of the present disclosure further provide mechanisms for LLM chaining-using the output from a first selected LLM as an input to a second LLM. This can allow a user to resolve complex tasks having multiple layers by employing the selected LLMs that are desired for/excel at processing those different layers. These and other aspects of the present disclosure will be described in further detail below with respect to the accompanying drawings.

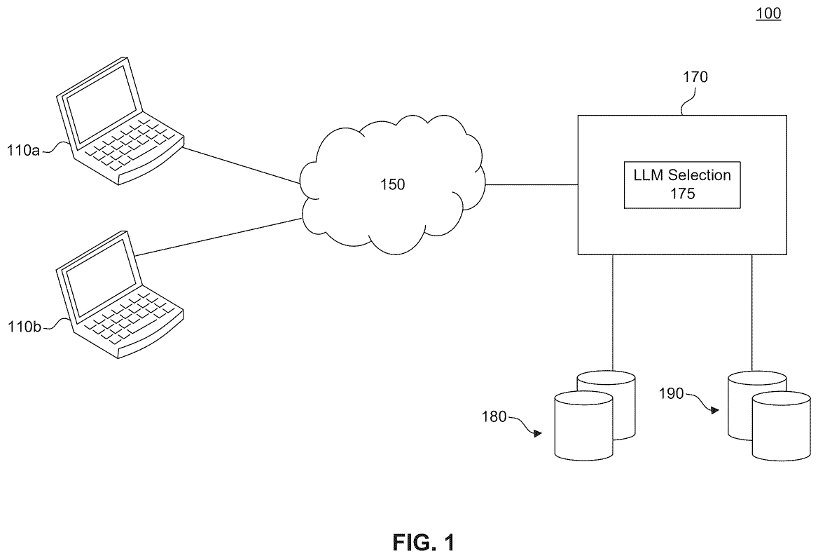

FIG. 1 illustrates a block diagram of an exemplary LLM selection environment 100, according to aspects of the present disclosure. As shown in FIG. 1, the environment 100 includes user devices 110a and 110b, which take the form of a mobile device, personal computer 120, or other electronics device capable of communicating over a network, such as a smartphone, tablet computer, personal digital assistant, smartwatch, etc. The environment 100 also includes a host system 170. In aspects, the host system 170 may include all interfaces and functionality in support of the subscriber, as well as internal systems. Included within the host system 170 is an LLM selection system 175.

As shown in FIG. 1, the user devices 110a and 110b connect to the host system 170 and the LLM selection system 175 over a network 150. In aspects, network 150 may be any type of computer or telecommunications network capable of communicating data, including but not limited to a local area network, a wide-area network (e.g., the Internet), or any combination thereof. The network may include wired and/or wireless segments. In some aspects, network 150 may be a secure network. In some aspects, one or more of the user devices 110a and 110b may reside within network 150.

As shown in FIG. 1, the host system 170 may have accesses to a plurality of databases or libraries, including an LLM library 180 and a customer database 190. In an aspect, the customer database 190 may include data relating to the specific company accessing the service, its employees, or business accounts associated with the company or its employees, such as one or more sales accounts. In aspects, the LLM library 180 and the customer database 190 may be located within the host system 170, separate from the host system 170 but still locally, or may be accessible by the host system 170 and LLM selection system 175 via network 150.

In operation, a user of user device 110a or 110b accesses the LLM selection system 175 via network 150. In a user interface associated with this access, the LLM selection system 175 provides the user with a list of available LLMs. The user makes a selection of a particular LLM and then provides the LLM selection system 175 with a request. The LLM selection system 175 retrieves the LLM syntax associated with the selected LLM from the LLM library 180. The LLM system 175 generates a prompt based on the received request and the retrieved syntax, and then prompts the selected LLM with the generated prompt. In aspects, the LLMs are all stored and function on the LLM library 180, which may constitute one or more servers, databases, APIs, or virtualized environments. The LLM selection system 175 receives the response from the selected LLM, and then processes and our outputs the response to the user. This will be described in further detail below with respect to the remaining figures.

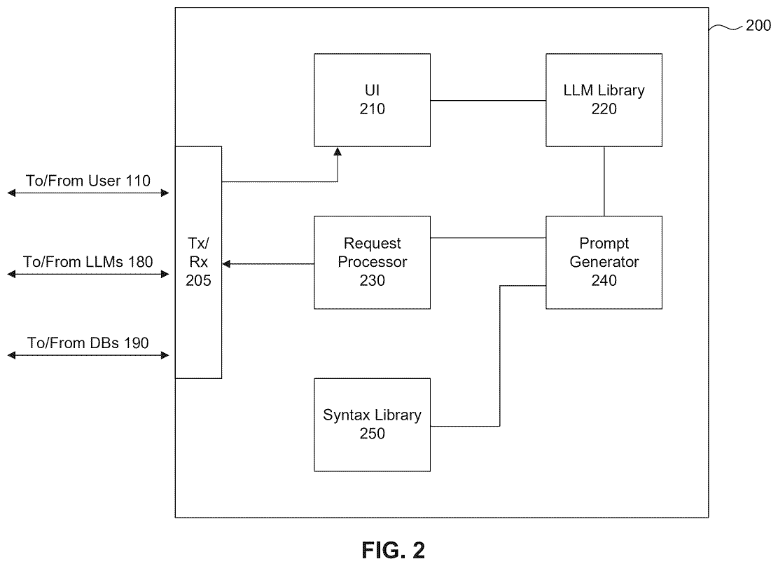

FIG. 2 illustrates a block diagram of an exemplary LLM selection system 200 according to aspects of the present disclosure. As shown in FIG. 2, the LLM selection system 200 includes a transceiver 205, a UI 210, an LLM library 220, a request processor 230, a prompt generator 240, and a syntax library 250. In aspects, the transceiver 205 is capable of communicating with local devices as well as over the network 150 using one or more digital communication protocols. In aspects, the transceiver 205 may be responsible for communicating with the user/user device 110, with the LLM library 180, as well as the customer databases 190.

While a user is in communication with the LLM selection system 200, a user interface UI 210 provides the primary go-between. The user interacts with the UI 210 to make LLM selections, provide a request, and receive output data from the system 200.

In an aspect, the LLM library 220 includes a listing of the available LLMs that can be used by the user. In aspects, the LLM library 220 may not only include the different LLMs that are available, but also different versions of those LLMs. When a user seeks to make an LLM selection, the UI 210 obtains information relating to the available LLMs from the LLM library 220. In aspects, the LLM library is updated in real-time as LLMs are added, removed, or updated in the LLM library 180.

Once the user makes an LLM selection, the user provides the system 200 with a request via the UI 210. In aspects, the UI 210 may prompt the user for the request. In aspects, the request may be one or more of natural language, Boolean language, LLM prompt language, and/or multi-modal, or a combination thereof. The request is received at the request processor 230. The request processor 230 performs any additional processing that may be required for generating the appropriate prompt to the LLM. For example, a request may include calls to external data, such as one or more files or records stored in the customer database 190. In this example, the request processor 230 may retrieve the relevant information from the customer database 190 before prompt generation. Similarly, certain customer requests may require “translation” into a more understandable format. This may particularly be true for a natural language request. Such translation may be rules based or involve one or more machine learning models in order to decipher the “meaning” and/or “intent” of the customer's request. Once the relevant processing has been performed, the request and the relevant translation or other data are provided to the prompt generator 240.

Prompt generator 240 performs generation of the actual prompt that will be provided to the selected LLM. First, each available LLM has certain metadata that must be retrieved in order to generate the prompt. In aspects, this metadata may include prompt syntax, templates, headers, footers, guardrails, versions, and policies. Prompt generator 240 retrieves this information from the syntax library 250. Then, using the retrieved metadata as well as the information received from the request processor 230, the prompt generator generates a prompt that will be supplied to the LLM. For example, for an LLM that lacks presumptive guardrails, these may be added to the prompt being generated, which is also formatted according to the selected LLM's designated syntax, having all necessary inputs defined by the selected LLM to generate responsive and accurate action by the selected LLM.

Guardrails are often used in LLM prompting to prevent the LLM from performing its analysis under perceived undesirable data trends. One example may be that of racial or economic bias. An LLM may be pre-programmed with a default guardrail to ignore perceived racial or economic bias when generating results and/or performing its analysis. However, an LLM that lacks such a guardrail may need to have this information included within its prompt. In various aspects of the present disclosure, the LLM selection system may check a selected LLM and compensate, if necessary, for a wide variety of different guardrails When an output is received from the selected LLM, the output is again provided to the request processor 230 for further processing. The request processor 230 may perform different functions depending on the output. For example, for a straightforward output, the request processor may simply forward the output to the user. However, certain other outputs may include new data to be written to the customer database 190, in which case the request processor 230 will communicate with and update the customer database accordingly before or after output to the user. Likewise, certain other outputs may require “re-translation” to place it in a form that can be readily understood by the user. As above, a rules based algorithm and/or machine-learning model may be used to perform this re-translation. Similar processing may be used by the request processor 230 to determine whether further processing is needed in the first place. The resulting output of the selected LLM is then provided to the user.

As discussed above, aspects of the present disclosure may allow for the user to select multiple LLMs for chaining a complex task. This operates substantially similarly to what was described above, except that the user selects multiple LLMs from the LLM library 220 through the user interface 210. In aspects, the user may also identify which portions of the request are to be performed by each selected LLM. The request processor 230 and prompt generator 240 processing steps are then performed on the initial request, as well as for each output of the intermediate LLMs until a final output is obtained. This final output is then processed by the request processor 230 in substantially the same manner as described above before output to the user. For each output, database writes and/or retrievals can be performed by the request processor 230, depending on the output.

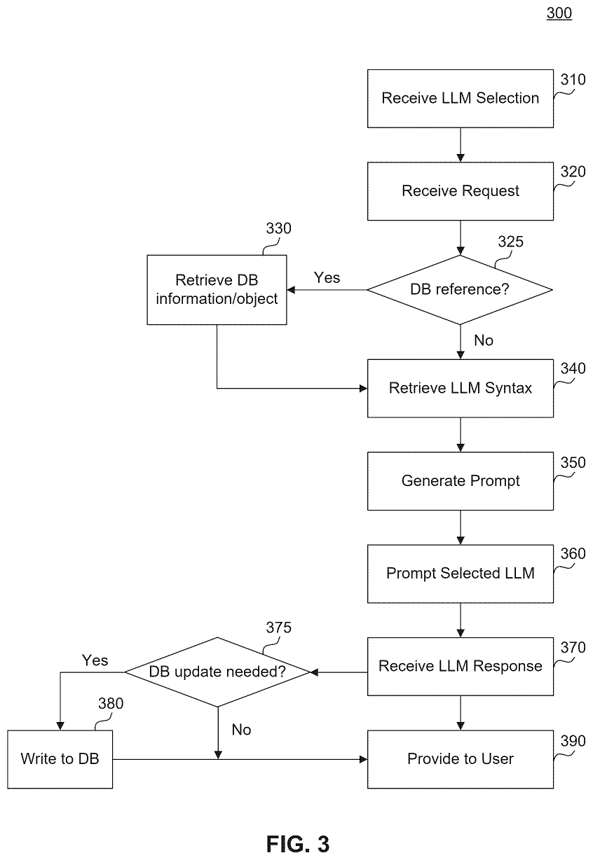

FIG. 3 illustrates a flowchart diagram of an exemplary method 300 for LLM selection according to aspects of the disclosure. As shown in FIG. 3, the method begins at step 310, with the LLM selection system receiving an LLM selection from a user device. In aspects, this can be received in response to the LLM selection system providing a list of available LLMs and/or LLM versions to the user device, or in response to the user conducting a search or other input for a specific requested LLM.

In step 320, the LLM selection system receives a request form the user. In aspects, the request can be in a variety of different forms, such as natural language, Boolean, etc. The request is received by the request processor 230, which parses the request for processing.

In step 325, the request processor 230 determines whether the request includes a database reference. Such a database reference may be a reference to any data stored locally or remotely that is expected to be retrieved in order to perform the requested processing. Examples of such data may include locally stored data, such as sales information and records, remotely stored information, such as company representative and contact information, or publicly available data, such as company address, stock price or history, revenue reports, etc.

If the request processor 230 detects a database reference (325—Yes), the request processor 230 retrieves the database information/objects from the relevant data sources in step 330. Depending on whether the data is stored locally, remotely, or publicly, this retrieval can include any of a database search query, remote storage retrieval operation, or an Internet or public database search. The information is then provided to the request processor for further processing in step 340. If the request does not include a database reference (325—No), then the method proceeds to step 340.

In step 340, the prompt generator 240 retrieves the syntax and other formatting information necessary to generate the AI prompt. In aspects, this can include retrieving metadata associated with the selected LLM that identifies certain prompting criteria associated with the selected LLM, such as preprogrammed guardrails, fields, acceptable field value ranges, formatting preferences, etc. In an aspect, this information is retrieved from the LLM library 220 or from one or more remote LLM databases or servers.

In step 350, the prompt generator automatically generates an AI prompt to be supplied to the selected LLM based on the retrieved LLM metadata. As such, the prompt will include the preprogrammed guardrails associated with the selected LLM, but also any additional guardrails implemented by the prompt generator that are not defaults of the selected LLM. The prompt generator 240 will generate the prompt so as to satisfy the user's request and in accordance with any formatting rules associated with the selected LLM.

In step 360, the selected LLM is then prompted with the prompt generated by the prompt generator 240. In aspects, this includes issuing a request or command to the selected LLM to generate an output responsive to the prompt.

In step 370, the request processor 230 receives a response from the LLM in response to the prompt, which the request processor 230 then reviews for further processing. For example, as discussed above, some LLM outputs may require certain follow-up actions such as re-translation, or database updating.

In step 375, the request processor 230 determines whether the output from the LLM includes data that should be added to, or used to update, a corresponding database. For example, a prompt may produce an output that calculates certain sales or productivity metrics that are meant to be stored in a database for future reference. When such data is detected by the request processor (375—Yes), then the request processor 230 generates a write command to the database to either write or overwrite the data into the database in step 380. Upon completion of the database update, the method proceeds to step 390.

If the request processor determines that there is no information included in the received LLM output that requires adding or updating to the database (375—No), then the method proceeds to step 390. In step 390, after the request processor has concluded output processing of the received response, the data provided to the user device.

It will be understood that the order of the above steps are merely exemplary, and the steps can be rearranged in any appropriate manner, and that the method can be modified consistent with the present disclosure. Additionally, more or fewer steps may be included in the exemplary method consistent with the disclosure. For example, in aspects, the method 300 may further include steps for the specific processing performed by the request processor on the output of the LLM.

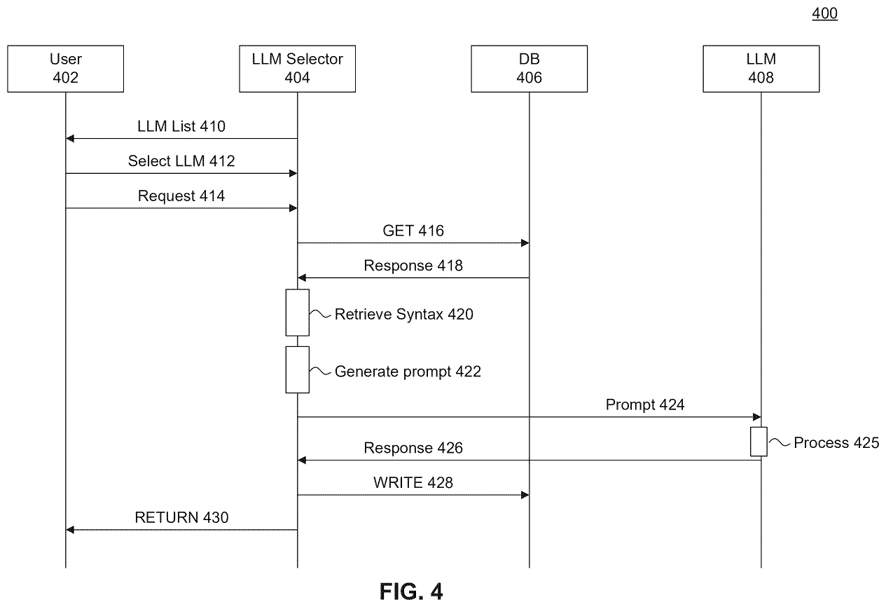

FIG. 4 illustrates a process flow diagram of an exemplary LLM selection process 400 according to aspects of the present disclosure. As shown in FIG. 4, the process occurs between a user device 402, an LLM selection system 404, a database 406, and a selected LLM 408. In aspects, these elements represent exemplary aspects of user device 110, LLM selection system 175/200, customer database 190, and LLM library 180, respectively.

The process 400 begins with the LLM selection system 404 transmitted or otherwise providing a list of available LLMs to the user device 402 in step 410. As discussed above, certain aspects allow for other selection methods such as a customer search or text input string. The user device 402 response to the LLM selection system 404 with a selected LLM from among the available LLMs in step 412.

Subsequently, the user device 402 also provides the LLM selection system 404 with a request in step 414. In aspects, the request can include a description of the work to be done by the LLM 408, and may be in a variety of different formats. In aspects, the request may also include references to retrievable data either locally or remotely stored.

If the request includes references to such data, then the LLM selection system 404 gets the relevant data from database 406. For external data references, such as to publicly available information, the retrieval may require other operations, such as an Internet search. The database 406 then responds to the LLM selection system 404 with the queried or searched information in step 418.

The LLM selection system 404 then retrieves the relevant syntax information associated with the selected LLM in step 420. In aspects, this information can be retrieved from the LLM 408 directly, but in other aspects, this information will be obtained from local storage or from a local LLM syntax database. In aspects, this syntax information includes prompt metadata associated with the selected LLM, such as input fields, input value ranges, presumed guardrails, prompt format information, etc.

From the retrieved metadata, the LLM selection system 404 generates an LLM prompt for providing to the selected LLM in step 422. As discussed above, the generated prompt conforms to the metadata associated with the selected LLM.

The LLM selection system 404 then prompts the LLM in step 424 by initiating the LLM using the generated prompt. The LLM 408 processes the received prompt in step 425, and then transmits a response to the LLM selection system 404 in step 426. In aspects, the response includes one or more of an image, video, audio, or digital document, including spreadsheet, text file, multimedia file, etc.

Upon receipt of the response, the LLM selection system 404 performs any necessary writes to the database 406, and then generates a return output to the user device 402 in step 430.

It will be understood that the order of the above process steps are merely exemplary, and the steps can be rearranged in any appropriate manner, and that the process can be modified consistent with the present disclosure. Additionally, more or fewer steps may be included in the exemplary method consistent with the disclosure.

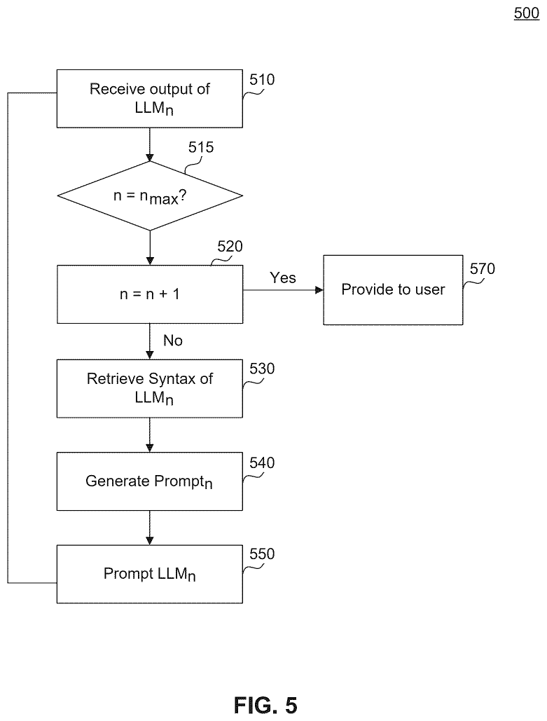

FIG. 5 illustrates a flowchart diagram of an exemplary LLM chaining method 500 according to aspects of the present disclosure. In aspects, the method 500 can be added to the LLM selection method shown in FIG. 3. In the example aspect of FIG. 5, the user device 110 has identified nₘₐₓ different LLMs that are to perform the processing.

Therefore, the method begins at step 510 with the receiving of the output from a current LLMₙ. In an aspect, this may be an initial LLM at the start of the method, whereas this output can be of subsequent chained LLMs as the method continues. As discussed above, this output can be obtained in substantially the same manner as described above with respect to FIG. 3. Following an output of a current LLMₙ, such as in the manner described above with respect to FIG. 3, the method 500 proceeds to step 515.

In step 515, a determination is made as to whether the current LLM is the last LLM. In other words, a determination is made as to whether all selected LLMs have provided their output by determining whether n=nₘₐₓ.

In step If this current output is not that of the final LLM (e.g., n≠nₘₐₓ; 525—No), then n is incremented by 1 in step 520 in order to represent that a next LLM in the selected chain of LLMs is to carry out its processing. The method then proceeds to step 530.

In step 530, the metadata associated with the current LLMₙ is retrieved. In aspects, the metadata information can be retrieved from a local repository of LLM metadata, or from an LLM server. In aspects, the LLM metadata includes syntax, formatting information, fields, field value ranges, presumed guardrails, etc.

In step 540, the LLM selection system 200 generates a prompt for the current LLM in the manner described above. As discussed above, the prompt is generated according to the metadata associated with the current LLMₙ. Additionally, in aspects, the prompt may be generated in order to produce a response from the current LLMₙ that is responsive to a current segment of the overall request. Examples of this may include performing a complex statistical analysis of certain sales numbers, or generating a table or picture to represent statistical findings of an earlier LLM.

In step 550, the LLM selection system 200 prompts the selected current LLMₙ with the generated prompt. This causes the current LLMₙ to perform processing responsive to the prompt, and to produce an output. This causes the method 500 to return to step 510, with the reception of the LLMₙ output. Once received, an updated check is performed to determine whether the output of the current LLM is that of the last LLM in the selected chain (e.g., whether n=nₘₐₓ). If it is (515—Yes), then the output from the LLM is provided to the user device 110.

In various aspects, the output to the user can be combined between the various outputs from the different LLMs in the chain. In alternative aspects, the outputs from each earlier selected LLM are updated and changed throughout the course of the processing by later LLMs until a single output is obtained. In either situation, prior to providing the output to the user, the request processor 230 may determine whether any updates to one or more databases are needed, and update any relevant databases accordingly.

It will be understood that the order of the above process steps are merely exemplary, and the steps can be rearranged in any appropriate manner, and that the process can be modified consistent with the present disclosure. Additionally, more or fewer steps may be included in the exemplary method consistent with the disclosure.

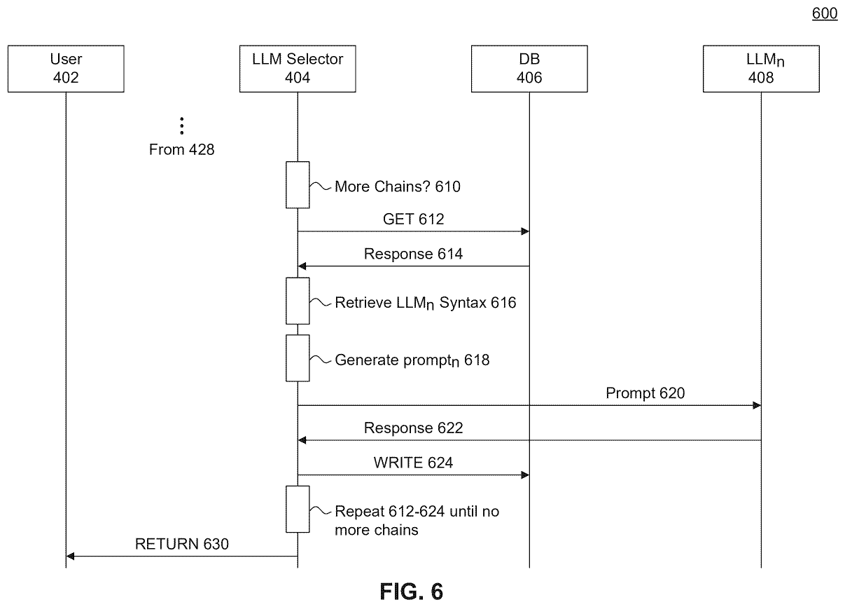

FIG. 6 illustrates a process flow diagram of an exemplary LLM chaining process 600 according to aspects of the present disclosure. As shown in FIG. 6, the process 600 occurs between the user device 402, the LLM selection system 404, the database 406, and a current LLMₙ. As further shown in FIG. 6, the process 600 starts with process steps 410-428 of FIG. 4, except that instead of the user device providing a single LLM selection, the user device provides a plurality of LLM selections that are to operate in the chain. In an aspect, the user device can also select the specific tasks and/or the order with which the selected LLMs are to operate.

The process 600 then continues at step 610, where a determination is made as to whether more LLMs remain in the chain that have not yet performed their processes. If not, then the process proceeds to step 630, where the LLM output is provided to the user. If there are more LLMs remaining in the chain, then the LLM selection system 404 increments the current LLM and retrieves relevant data from a database in step 612. In aspects, this may be data necessary to carry out a next process. In step 614, the requested data is received from the database 406.

In step 616, the LLM selection system 404 retrieves the LLM metadata associated with the current LLM. As discussed above, the metadata may include a variety of information useful in generating the LLM prompt, including specific formatting, fields, field value ranges, presumed guardrails, etc. associated with the current LLM. Based on this information the LLM selection system 404 generates the prompt for the current LLM in step 618.

In step 620, the LLM selection system 404 prompts the LLM 408 with the generated prompt. This causes the LLM 408 to carry out a process that results in a responsive output being provided to the LLM selection system 408 in step 622. Based on this response, the request processor 230 analyzes the response to determine whether any database updates should be made. If necessary, the database updates are carried out in step 624. In aspects, for a final output expected to involve multiple outputs from different LLMs in the chain of LLMs, intermediate outputs can be stored in the database for future retrieval and reference.

Although this concludes the processing for a current LLM in the chain, steps 612-624 are then repeated for all remaining LLMs in the chain until a final output is received from the last LLM 408. Once the final output is received from a last LLM in the chain, the process sends a response to the user device 402 in step 630. In aspects, this output can be a single output corresponding to the output of the last LLM in the chain, can be a combined or multi-modal output that includes at least portions of multiple LLM outputs in the chain, and/or can be output-processed by the request processor.

It will be understood that the order of the above process steps are merely exemplary, and the steps can be rearranged in any appropriate manner, and that the process can be modified consistent with the present disclosure. Additionally, more or fewer steps may be included in the exemplary method consistent with the disclosure.

FIG. 7 illustrates a user interface 700 according to aspects of the present disclosure. As shown in FIG. 7, the UI 700 includes a process flow 710 and an edit frame 725. In embodiments of the present disclosure, the process flow 710 is a visual representation of a flow to be carried out by a computing system. Because of its visual nature, users are able to “program” the process by adding visual elements to the flow 710.

For example, as shown in FIG. 7, the process flow 710 includes several visual process elements 705. These process elements 705 can take a wide variety of different forms, such as a start element that defines the start of the process flow, decision elements, action elements (e.g., get contact, assign contact, etc.), an end element that defines the end of the process flow.

In the example UI 700 of FIG. 7, the process flow 710 includes an action 715 referred to as “generate a call to action.” When selected, the edit frame 725 displays the properties and several editable fields associated with that action element 715. In the example of FIG. 7, the edit frame 725 allows the user to edit the name of the process element 705, as well as a description and other information.

In the example of FIG. 7, the action 715 is configured to receive, as input, the output from the previous node and produce an output based on an analysis by an LLM. In embodiments, the configuration of this LLM action can be edited in a separate UI, such as that shown in FIG. 8.

FIG. 8 illustrates a user interface 800 according to aspects of the present disclosure. As shown in FIG. 8, the UI 800 includes a prompt template frame 805 that shows the example prompt language that will be used to activate the LLM. In the example shown in 805, the prompt template includes several variables that will be used by the prompting system to generate the final prompt. For each such variable, the system will retrieve appropriate data for filling those variable. This will result in a final prompt that can be then provided to the LLM.

The UI 800 also includes a template properties frame 815. In the example of FIG. 8, the template properties frame 815 includes a model type selection menu 820, and a model selection menu 825. In the example of FIG. 8, each of the model type selection menu 820 and the model selection menu 825 are displayed as drop-down menus. The model type selection menu 820 allows the user to select a type of the LLM to be used. Selection of a particular type in menu 820 will cause a change in the LLMs listed in the models menu 825, all of which will conform to the selected type. The models menu 825 displays all available LLMs that are available and conforming to the selected LLM type. The user is able to scroll through the menu 825 and select their preferred LLM.

Once the configurations of the action have been saved, LLM selection for the selected action 715 has been completed.

Using the same user interfaces of FIGS. 7 and 8, the user can also effect LLM chaining. For example, as discussed above, the user is able to add another visual node to the flow 710 in UI 700, such as action 720. Like action 715, action 720 can also be defined as an LLM action. Therefore, by being placed at or near the output of the action 715, the LLM of action 720 will operate on the output from action 715. Additionally, by selected the detailed properties of action 720, the user will be shown a UI, such as UI 800 shown in FIG. 8. In UI 800, the user is able to configure the specific LLM to be used, as well as the prompt template with which to prompt the selected LLM. In this manner, the user is able to visually, and without coding or specific coding prompting knowledge, program LLM chaining within a process flow 710.

Various aspects may be implemented, for example, using one or more well-known computer systems, such as computer system 900 shown in FIG. 9. One or more computer systems 900 may be used, for example, to implement any of the aspects discussed herein, as well as combinations and sub-combinations thereof, including but not limited to the LLM selection system 200, the request processor 230, the prompt generator 240, and/or the LLM.

Computer system 900 may include one or more processors (also called central processing units, or CPUs), such as a processor 904. Processor 904 may be connected to a communication infrastructure or bus 906.

Computer system 900 may also include customer input/output device(s) 903, such as monitors, keyboards, pointing devices, etc., which may communicate with communication infrastructure 906 through customer input/output interface(s) 902.

One or more of processors 904 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 900 may also include a main or primary memory 908, such as random-access memory (RAM). Main memory 908 may include one or more levels of cache. Main memory 908 may have stored therein control logic (i.e., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 may include a computer usable or readable storage device having stored thereon computer software (control logic) and/or data. Removable storage unit 918 may be a floppy disk, magnetic tape, compact disk, DVD, optical storage disk, and/any other computer data storage device. Removable storage drive 914 may read from and/or write to removable storage unit 918.

Secondary memory 910 may include other means, devices, components, instrumentalities or other approaches for allowing computer programs and/or other instructions and/or data to be accessed by computer system 900. Such means, devices, components, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 may further include a communication or network interface 924. Communication interface 924 may enable computer system 900 to communicate and interact with any combination of external devices, external networks, external entities, etc. (individually and collectively referenced by reference number 928). For example, communication interface 924 may allow computer system 900 to communicate with external or remote devices 928 over communications path 926, which may be wired and/or wireless (or a combination thereof), and which may include any combination of LANs, WANs, the Internet, etc. Control logic and/or data may be transmitted to and from computer system 900 via communication path 926.

Computer system 900 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 900 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 900 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 900, main memory 908, secondary memory 910, and removable storage units 918 and 922, as well as tangible articles of manufacture embodying any combination of the foregoing. Such control logic, when executed by one or more data processing devices (such as computer system 900), may cause such data processing devices to operate as described herein.

Based on the teachings included in this disclosure, it will be apparent to persons skilled in the relevant art(s) how to make and use aspects of this disclosure using data processing devices, computer systems and/or computer architectures other than that shown in FIG. 9. In particular, aspects can operate with software, hardware, and/or operating system implementations other than those described herein.

It is to be appreciated that the Detailed Description section, and not any other section, is intended to be used to interpret the claims. Other sections can set forth one or more but not all exemplary aspects as contemplated by the inventor(s), and thus, are not intended to limit this disclosure or the appended claims in any way.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described can include a particular feature, structure, or characteristic, but every aspect can not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents. This listing of claims will replace all prior versions, and listings, of claims in the application.

1. A method, comprising:
retrieving, by one or more computing devices, metadata associated with a Large Language Model (LLM) selected from among a plurality of available LLMs based on a request, the metadata defining a plurality of prompting criteria, including syntax and formatting information, associated with the selected LLM;
generating, by the one or more computing devices, an LLM prompt based on the request and conforming to the plurality of prompting criteria defined by the retrieved metadata; and
prompting, by the one or more computing devices, the selected LLM with the generated prompt to generate an output responsive to the request.

2. The method of claim 1, further comprising:
identifying, by the one or more computing devices, an external data reference in the request; and
retrieving, in response to the identifying, a data file corresponding to the external data reference from one of a local storage, a network storage, or the Internet based on a type of the external data reference.

3. The method of claim 1, wherein the metadata includes a plurality of fields, value ranges associated with the plurality of fields, and any presumed guardrails associated with the selected LLM.

4. The method of claim 3, further comprising:
determining, based on the receivedretrieved metadata, whether the presumed guardrails are missing a required guardrail,
wherein the generating of the LLM prompt includes generating the required guardrail.

5. The method of claim 3, wherein the LLM prompt is generated conforming to the syntax, and including the plurality of fields included in the metadata.

6. The method of claim 1, wherein the request includes a plurality of selections of available LLMs.

7. The method of claim 6, further comprising:
providing, by the one or more computing devices, the output from the selected LLM to a second LLM from among the plurality of selected available LLMs.

8. A system, comprising:
a memory configured to store operations; and
one or more processors configured to perform the operations, the operations comprising:
retrieving metadata associated with a Large Language Model (LLM) selected from among a plurality of available LLMs based on a request, the metadata defining a plurality of prompting criteria, including syntax and formatting information, associated with the selected LLM;
generating an LLM prompt based on the request and conforming to the plurality of prompting criteria defined by the retrieved metadata, and
prompting the selected LLM with the generated prompt to generate an output responsive to the request.

9. The system of claim 8, wherein the one or more processors are further configured to perform operations comprising:
identifying one or more external data references in the request; and
retrieving, in response to the identifying, a data file corresponding to the external data reference from one of a local storage, a network storage, or the Internet based on a type of the external data reference.

10. The system of claim 8, wherein the metadata includes a plurality of fields, value ranges associated with the plurality of fields, and any presumed guardrails associated with the selected LLM.

11. The system of claim 10, wherein the one or more processors are further configured to:
determine, based on the retrieved metadata, whether the presumed guardrails are missing a required guardrail,
wherein the generating of the LLM prompt includes generating the required guardrail.

12. The system of claim 11, wherein the prompt is generated conforming to the syntax, and including the plurality of fields included in the metadata.

13. The system of claim 8, wherein the request includes a plurality of selections of available LLMs.

14. The system of claim 13, wherein the one or more processors are further configured to provide the output from the selected LLM to a second LLM from among the plurality of selected LLMs.

15. A non-transitory computer-readable storage device having instructions stored thereon, execution of which, by one or more processing devices, causes one or more processors to perform operations comprising:
receiving a request from a user device that includes selection of an available LLM from among a plurality of available LLMs;
retrieving metadata associated with the selected LLM, the metadata defining a plurality of prompting criteria, including syntax and formatting information, associated with the selected LLM;
generating an LLM prompt based on the received request and the retrieved metadata; and
prompting the selected LLM with the generated prompt to generate an output responsive to the request.

16. The non-transitory computer-readable storage device of claim 15, the operations further comprising:
identifying an external data reference in the request; and
retrieving a data file corresponding to the external data reference from one of a local storage, a network storage, or the Internet.

17. The non-transitory computer-readable storage device of claim 15, wherein the metadata includes a plurality of fields, value ranges associated with the plurality of fields, and any presumed guardrails associated with the selected LLM.

18. The non-transitory computer-readable storage device of claim 17, wherein the operations further include:
determining, based on the retrieved metadata, whether the presumed guardrails are missing a required guardrail,
wherein the generating of the LLM prompt includes generating the required guardrail.

19. The non-transitory computer-readable storage device of claim 15, wherein the request includes a plurality of selections of available LLMs.

20. The non-transitory computer-readable storage device of claim 19, the operations further comprising providing the output from the selected LLM to a second LLM from among the plurality of selected LLMs.
